(19) United States
(12) Patent Application Publication
(10) Pub. No.: US 2007/0266801 A1
(43) Pub. Date: Nov. 22, 2007

(54) Reversible Sealing of Microfluidic Arrays

(76) Inventors: Alireza Khademhosseini, Cambridge, MA (US); Jeffrey T. Borenstein, Newton, MA (US); George Eng, New York, NY (US); Judy Yeh, Cambridge, MA (US); Robert S. Langer, Newton, MA (US)

Correspondence Address: CHOATE, HALL & STEWART LLP, TWO INTERNATIONAL PLACE, BOSTON, MA, 02110, US

(21) Appl. No.: 11/612,142

(22) Filed: Dec. 18, 2006

Related U.S. Application Data
(60) Provisional application No. 60/751,350, filed on Dec. 16, 2005.
(60) Provisional application No. 60/747,910, filed on May 22, 2006.

(51) Int. Cl. G01N 1/20

(52) U.S. Cl. 73/863.91

(57) ABSTRACT

Channel arrays are reversibly disposed over an array of microwells to deliver materials, for example, cells, to the microwells.

### CROSS-REFERENCE TO RELATED APPLICATIONS

The present application claims the benefit of and priority to copending U.S. provisional application No. 60/751350, filed Dec. 16, 2005, and U.S. provisional application No. 60/747910, filed May 22, 2006, the entire contents of both of which are herein incorporated by reference.

### BACKGROUND OF THE INVENTION

There has been great interest in testing the beneficial effects of both new and old drugs on multiple diseases. For example, aside from the ability of aspirin to relieve pain, it is currently being examined as a cancer preventative. Also, drugs which treat erectile dysfunction, such as Viagra, are currently being tested to treat pulmonary hypertension. This need to test existing drugs for new indications and the increasing ability to use combinatorial chemistry to synthesize large libraries of novel compounds have increased the demand for screening the effects of biochemical signals on multiple cell types in a highly parallel manner. Traditional methods to perform such experiments are expensive and limited in the number of tests that can be performed. For example, commonly used methods for high throughput analysis involve the use of multi-well plates (i. e., 384 or 96 well plates) that are operated using cumbersome manual or expensive robotics based operations. Therefore, developing a technology that can perform such tasks in a cheaper, easier, and a higher throughput manner may be beneficial in a number of fields, ranging from drug discovery to tissue engineering.

Microscale approaches such as cellular micropatterning and microfluidics hold great promise to perform high throughput experimentation. Recently, methods to simultaneously test different extracellular matrix proteins and synthetic materials on the behavior of embryonic stem (ES) cells have been elegantly demonstrated through the use of robotic based surface deposition. In these approaches, an array of adhesive regions, each containing a unique extracellular material, was tested for their ability to direct the differentiation of ES cells. Aside from testing various stimuli on the same cell type, it is potentially important to test the effect on multiple cell types. Previous approaches to fabricate multiphenotype arrays involved a number of techniques such as patterned co-cultures and capturing cells within photocrosslinking or natural polymers. In patterned co-cultures, two cell types are positioned relative to each other, either by using selective adhesion of one cell type relative to the other to a patterned substrate or by using the reversible adhesive properties of the substrate to position a cell type relative to the other cell type. Patterned co-cultures are useful for controlling homotypic and heterotypic cell-cell interactions and enhancing the function of cell types that are hard to maintain in vitro (such as hepatocytes) through introduction of support cells that provide the signals to maintain these cells in culture. However, most patterned co-cultures to date only employ two cell types patterned relative to each other. Although micropatterning and microfluidics are useful for controlling the microenvironment and probing cellular interactions in cell culture, techniques for co-culture based on those two platforms are needed. One such approach involves immobilization of cells within photocrosslinkable hydrogels using an injection molding technique. Such systems have been used to pattern multiple cell types on a two dimensional substrate. Despite the significant capability of this approach, some potential challenges include the use of toxic photoinitiators and radiation to immobilize the cells inside the channels and the need for expensive photolithographic patterning equipment. Also, by photocrosslinking the cells in a hydrogel, it is harder to retrieve the cells for subsequent analysis.

### SUMMARY OF THE INVENTION

In various aspects, the inventions provide method that, provides a substrate having a plurality of wells arranged in a predetermined pattern, sealingly disposing a first removable channel array on the substrate, the removable channel array having a plurality of channels arranged such that first predetermined portions of the wells are disposed under predetermined channels, flowing a material through at least a first portion of the channels of the first removable channel array, removing the first removable channel array from the substrate, sealingly disposing a second removable channel array on the substrate, the removable channel array having a plurality of channels, wherein the wells of a least one of the first predetermined portions are disposed under different channels than one another, and flowing a material through at least a first portion of the channels of the second removable channel array.

In various embodiments the methods include removing the second removable channel array from the substrate, sealingly disposing a third removable channel array on the substrate, the removable channel array having channels arranged such that a second predetermined portion of the wells are disposed under predetermined channels, and flowing a material through at least a first portion of the channels of the third removable channel array.

The first material may be flowed through a first portion of the channels and a second material may be flowed through a second portion of the channels. A different material may be flowed through each of the channels.

The channel array, the substrate surface, or both, may be fabricated from poly(dimethyl siloxane), glass, silicon dioxide, or a fluoropolymer. The walls of the wells may treated with a material to modify their hydrophilicity, protein affinity, cell affinity, or any combination of these. Exemplary materials, include but are not limited to, poly(3-trimethoxysilyl)-propylmethacrylate-r-poly(ethylene glycol) methyl ether (TMSMA-r-PEGMA), organosilanes that form self-assembled monolayers, or ethanol.

The walls of the channels may be treated with a material to modify their hydrophilicity, protein affinity, cell affinity, or any combination of these. For example, PEG having a predetermined molecular weight and end group may be flowed through each of the channels.

In various aspects, the present invention provides a method for producing a combinatorial library of multiphenotypic cells. In various embodiments the methods include providing a substrate having a plurality of wells arranged in a predetermined pattern, depositing at least one cell in each well, sealingly disposing a first removable channel array on the substrate, the removable channel array having a plurality of channels arranged such that first predetermined portions of the wells are disposed under predetermined channels, and modifying a characteristic of the cells by flowing at least a first material through at least a first portion of the channels.

In various embodiments the methods include removing the first channel array from the substrate and placing a second removable channel array on the substrate such that at least a first portion of each of the predetermined portions of the wells are disposed under different channels than a second portion of each of the predetermined portions. Each well of each of the predetermined portions of the wells may be disposed under a different channel of the second removable channel array. The method may be repeated with a third removable channel array.

The first material may include a targeting agent, a nutrient medium, a pharmaceutically active agent, a contrast agent, or a growth factor.

Depositing at least one cell may include sealingly disposing a first removable channel array on the substrate, the removable channel array having a plurality of channels arranged such that predetermined portions of the wells are disposed under predetermined channels and flowing a suspension of a solvent and cells through each of the channels. The flow of the suspension may be stopped for a predetermined time interval, thereby allowing cells to settle into the wells, and renewing the flow of the solvent through the channels.

The foregoing and other aspects, embodiments, and features of the present inventions can be more fully understood from the following description and drawings.

### BRIEF DESCRIPTION OF THE DRAWING

FIG. 1 Schematic diagram of reversible sealing of microfluidic arrays onto microwell patterned substrates to fabricate multiphenotype cell arrays according to various embodiments of the invention.

FIG. 2 Leak-proof reversibly sealed microfluidic channels according to various embodiments of the invention: (A-B) represent the reversible sealing of a primary PDMS microfluidic mold on an array of wells while (C) represents the reversible sealing of a secondary array of channels on a substrate that was previously sealed. In (A) and (C) Trypan blue and PBS were flowed in alternating channels. In (B) red (rhodamine) and green (FITC) dyes in PBS (10 μg mL⁻¹) were flowed through the channels. The dye solutions did not leak, indicating that primary and secondary sealing of PDMS/PDMS can be performed. Note: (A) is a combined series of pictures to capture the entire microfluidic device.

FIG. 3 Cell docking within microchannel arrays according to various embodiments of the invention: (A) represents the light microscopy image of ES cells flowing within an array of microchannels; (B) is the fluorescent image of cells (right to left: ES/AML12/Saos-2/PC3/NIH-3T3 cells) labeled with membrane dyes CFSE (green) and SYTO (red) as they flow through the channels. (C) Once the cells had docked in the microwells, a cell-free solution was flowed through the channels to remove any remaining non-adhered cells.

FIG. 4 Formation of multi-phenotype cell arrays on two-dimensional substrates or within microfluidic channels according to various embodiments of the inventions: (A-C) show the light and fluorescent microscope images of the steps required in fabricating multiphenotype arrays. The fluorescent images are those of various cell types stained with two membrane dyes, CFSE (green) and SYTO (red) (right to left: ES/AML12/NIH-3T3 cells). (A) Each cell type was allowed to dock within microwells inside a microchannel. (B) The cells remained stable inside the microwells even after the PDMS mold was removed, giving rise to multiphenotype cell arrays. (C) Secondary microchannel molds were aligned orthogonally and reversibly sealed on the patterned substrates, resulting in wells that contained multiple cell types.

FIG. 5 Microfluidic arrays with upstream microfluidic mixers according to various embodiments of the inventions.

FIG. 6 shows images according to various embodiments in which a concentration gradient was generated in an array of channels (A) without cells and (B) with a monolayer of NIH-3T3 cells immobilized in a microfluidic array.

### DETAILED DESCRIPTION OF VARIOUS EMBODIMENTS

In various embodiments, a substrate is produced with wells arranged in a predetermined pattern. A channel array is disposed on the substrate to site various wells under the different channels of the array, and a material is flowed through at least a portion of the channels. The channel array may then be removed and either rotated or replaced with a second channel array. Different groups of wells may be sited under common channels than for the first array, so that wells that were initially contacted with different materials may be contacted with the same material in this second step.

An exemplary approach to fabricate arrays of many different cell types combines the ability to reversibly seal microfluidic channels on patterned substrates with the ability to capture cells in shear protected regions of microfluidic channels. The technique can be efficiently used to produce multiphenotype cellular arrays on two dimensional substrates or within individual microchannels. In various embodiments, two PDMS molds containing either microchannels or microwells were fabricated and subsequently reversibly sealed to each other so that the microwells were positioned within the channels. Each cell type was flowed through a unique microchannel, and deposited into the microwells within that channel. After the cells were deposited, the microfluidics mold was peeled from the substrate while leaving the cells within the microwells, which generated a patterned array of multiple cell types. In order to facilitate high-throughput delivery of reagents to the various cell types, a secondary PDMS mold may be subsequently aligned orthogonal to the direction of the first array of channels. In this approach, each microwell on the substrate could potentially be used to perform a separate experiment. Microfluidic gradient generators upstream from the array of channels may be used to lower the number of independent inlets required and facilitate the delivery of a higher number of solutions to the various cell types.

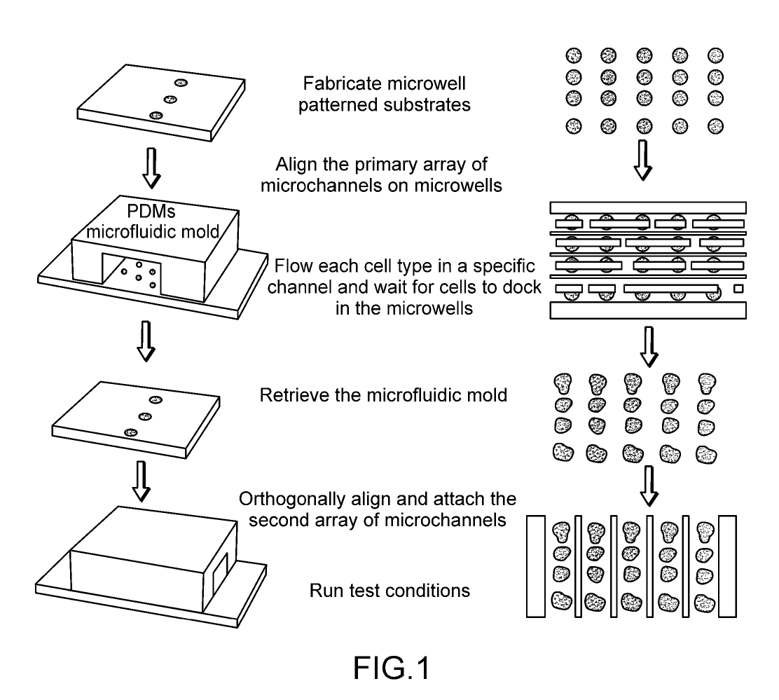

FIG. 1 illustrates an exemplary technique to fabricate multiphenotype cell arrays. This approach utilizes: (1) capturing cells within microstructures that contain low shear stress regions; (2) reversibly sealing elastomeric molds onto patterned substrates; and (3) orthogonally placing a series of microchannel arrays to deliver a unique set of fluids to particular ‘spots’ on a two-dimensional surface.

Cells can be captured within PEG microstructures and remain shear protected inside a variety of microstructures. This approach, in various embodiments, could provides a number of potential advantages for the fabrication of cell arrays, such as topographical heights as a barrier to localize cells in particular spots and the ability to pattern cells without the need for slow ‘cell adhesive’ processes. For example, the presence of microstructures allows for capturing multiple cells in the form of aggregates, which mimics the three-dimensional architecture of cell structures in vivo. These low shear stress microwells could be formed with protein coated or non-adhesive surfaces, making them useful for both anchorage dependent or anchorage independent cell types.

Although irreversible sealing is desired for devices comprised of static microchannels, reversibly sealed microchannels have been shown to be useful applications such as surface patterning, in which a channel array is used to pattern a material on a substrate and then removed. The channel arrays are capable of forming reversible sealing by simply pressurizing the channel array against the substrate. The pressure may either be positive or negative. For example, clamps or other like devices may be used to impart positive pressure, while reservoirs may be placed between the channel array and the substrate to contain a vacuum. The ability to use multiple sets of channels facilitates construction of complex patterns. In various embodiments, the cells were flowed through channels that had been reversibly sealed onto a substrate containing microwells.

In various embodiments, an elastomer such as poly(dimethyl siloxane) PDMS is used to fabricate a microwell patterned substrate and a separate channel array. For example, a silicon substrate may be coated with a photoresist, for example, SU-8 photoresist, available from MicroChem Corp. The resist may be patterned through a mask to produce a negative of the pattern desired for the substrate or the channel array. For example, the resist may be patterned to form an array of islands to produce the microwells. The islands (and resulting microwells) may have a diameter between 1 μm and 1 mm, for example, between 1 and 10 microns, between 10 and 100 microns, between 100 and 500 microns, or between 500 microns and 1 mm, and a height (depth) between 1 μm and 1 mm, for example, between 1 and 10 microns, between 10 and 100 microns, between 100 and 500 microns, or between 500 microns and 1 mm. The optimal island (and therefore well) size may be adjusted depending on the cell type to be employed in the method, for example, the cell size or degree of adhesion to the wells, or the particular processes that will be taking place within the wells.

A PDMS positive replica can be produced by curing a 10:1 mixture of silicon elastomer and a curing agent on the patterned silicon master at 70° C. for 2 hours. A variety of elastomer precursors and curing agents are commercially available, and one skilled in the art will be able to identify those suitable for use with embodiments of the inventions. The resulting substrate and channel array may be used to produce a combinatoric microreactor or may be used as a master for the fabrication of additional substrates and channel arrays. Exemplary additional materials include, but are not limited to, glass, silica, and fluoropolymers. We found that when photocrosslinkable PEG fabricated devices were used to create a reversible seal, significant leaking was observed. Without being bound by any particular theory, this may be caused by the permeability of PEG microstructures to water, which allowed the water to penetrate the substrates and move from one channel into the surrounding channels (data not shown).

Lithographic or other techniques known to those of skill in the art may be used to pattern practically any material for use as a substrate or channel array. Exemplary additional methods are disclosed in U.S. Pat. No. 6,197,575 to Griffith, et al., the entire contents of which are incorporated herein by reference. In general, the surface may be smooth so that the channel array and substrate surfaces form a good seal. Unmodified PDMS surfaces form a reversible seal, and, elastomeric materials may be easier to separate from one another. Of course, the bulk of the channel array, or substrate, or both, may be fabricated from one material whose surface is then coated with a second smooth and/or elastomeric material. This allows the channels or wells to have one surface composition while the contacting surfaces of the channel array and substrate have another.

While the perimeter of the microwells may have any shape, a circle can provide the same fluid flow path regardless of the direction of flow. Where there are two or orthogonal directions of flow, a square well can provide a consistent fluid flow path. The depth of the microwells may also vary across the well; one skilled in the art will recognize that it may be desirable to fabricate multiple layers of material on the substrate or to use other lithographic techniques to form microwells with this type of geometry. The wells may also be formed with a dam or speed-bump type structure on the incident sides (e.g., inlet side) of each well. Of course, where the orientation of microchannels is rotated, each well could have several “inlet” directions. The silicon wafer may be formed with patterns of channels to fabricate the PDMS channel arrays. The channels may have a width of 1 μm to 1 mm, for example, between 1 and 10 microns, between 10 and 100 microns, between 100 and 500 microns, or between 500 microns and 1 mm, and a depth of 1 μm to 1 mm, for example, between 1 and 10 microns, between 10 and 100 microns, between 100 and 500 microns, or between 500 microns and 1 mm. The optimal channel size can depend, e.g., on the size of the wells and the processes taking place within the wells, for example, the size of the cells.

The microwells may also be fabricated to expose the cells to a particular pattern of flow. Where the cells are not adherent to the walls of the well, it may not be desirable to flow material through the wells for fear of washing the cells out. Cells are responsive to mechanical stimuli, and the flow of fluid across the wells may be modified to reduce the exposure of the cells to the roughly laminar flow.

The channel arrays, each containing an array of microchannels, may be machined to connect the microchannels to a supply and drain for fluids. For example, the holes may be drilled through the inlets and the outlets. Reservoirs, for example, of about 3mm in diameter, may be cut into the inlets as well. The microchannels may be connected to a drain via tubing sealed in the outlet hole. For example, metal tubing may be sealed into the outlet hole with epoxy.

In various embodiments, the substrate is produced without microwells. Cells or other materials may be adhered to the substrate, using, for example, cell adhesion promoters which may be flowed through the channels to form aisles of cell adhesive regions. Flowing cells perpendicular to these aisles can cause them to attach at discrete regions on the substrate. Soft lithography techniques may be employed to prepare regions on the substrate that can provide an attachment location for cells, proteins, nucleic acids, or other molecules, for example, via chelation, hydrogen bonding, ionic bonding, etc. For example, strepavidin may be tethered to the surface using a self-assembled monolayer and used to immobilize a biotinylated material.

The channel arrays and substrates may be plasma cleaned, for example, for about 30-45 s, to render them hydrophilic. The regions of the substrates and channel arrays that contact each other may be rendered hydrophilic, and the remaining surface of the substrates and channel arrays may be protected, for example, with a reversibly sealed piece of PDMS, so that they remain hydrophobic.

Of course, the number of channels in a channel array and the number of microwells in the substrate may be coordinated. Where the microwells are not arranged in a square, multiple configurations of channel arrays may be needed to provide channels oriented in different directions.

The channel arrays and substrates may be equipped with optical or mechanical alignment aids to increase the accuracy of placement. For example, the channel arrays and substrates may have opaque markers that may be aligned for proper placement, or they may include complementary divots and protrusions.

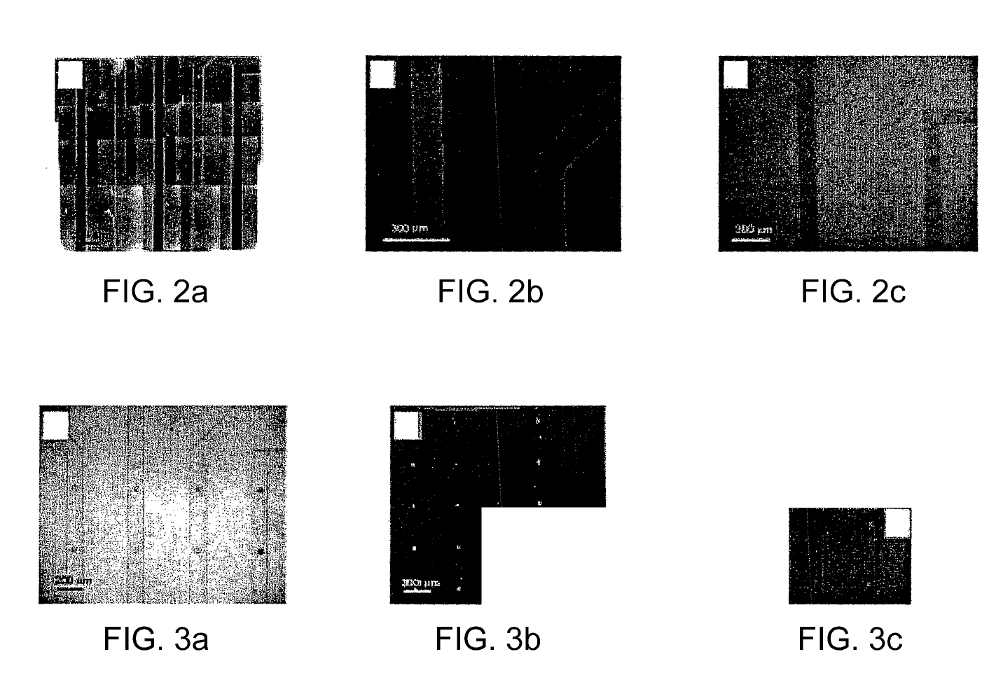

To produce a microfluidic combinatorial reactor, the channel array can be placed over the substrate such that each row of wells is centered within the channels. We found that reversibly sealed PDMS microchannels frequently leaked even under low positive pressures and flow rates of ˜1 μl min⁻¹ across the channel. To alleviate this problem, we used negative suction head by drawing the liquid from a common outlet on the microchannel arrays. As can be seen in FIG. 2, this setup eliminated leaking from the channels for both primary (FIG. 2A-B) and secondary PDMS channels (FIG. 2C). Furthermore, by having a common outlet, a single syringe and pump assembly was sufficient to regulate the fluid flow through many channels. Clamps could also be used to enhance channel sealing, but the use of negative suction head (i.e. syringe pump drawing fluid from a common outlet) minimized the need for clamping. Clamps may also be used to prevent slippage.

The surfaces of the channel arrays and substrates may be modified to optimize their interactions with various materials flowing through the reactor. Since PDMS is typically hydrophobic and even under plasma oxidation does not become fully hydrophilic, as measured by contact angles of 73°±1° and 51°→2° respectively, air bubbles can be captured within the microchannels. To reduce bubble formation, ethanol may be flowed through the channels (e.g., >10 microliters/min) to prevent bubble formation, followed by a PBS or water wash to fill the channels. The ethanol fills the microwells. The ethanol has a lower surface contact angle either without (33°±2°) or with (15°±0.5°) oxygen plasma treatment, which allows it to wet the surface and fill the microwells.

Alternatively or in addition, a solution of about 10 mg/mL of a silane-based anchoring PEG polymer such as poly(3-trimethoxysilyl)-propylmethacrylate-r-poly(ethylene glycol) methyl ether (TMSMA-r-PEGMA) in ethanol may be flowed over plasma treated surfaces for about 2 hours. The silane-based polymer spontaneously forms a polymeric monolayer on plasma-treated channels and can also be used to form monolayers on untreated oxygen-bearing surfaces. Without being bound by any particular theory, it is expected that PEG surface modification could reduce protein adhesion of up to 98% and cell adhesion of up to 99% without modifying the leaking properties. Other silane-anchored chemical groups may also be used to modify the walls of the channels and wells. For example, hydroxylated organosilanes can form hydrophilic coatings, while fluorinated organosilanes can form hydrophobic coatings. A wide variety of silanes that form self-assembled monolayers are available from commercial sources such as Fluka and Sigma-Aldrich. In various embodiments, surfaces may be oxygen plasma treated to make the channels more hydrophilic or change the surface protein and cell adhesive properties.

In various embodiments, it may be desirable to increase cell adhesion in the wells. For example, the substrate surface may be patterned with a cell repulsive monolayer, while the interior of the wells are provided with a silane-tethered cell adhesion promoter such as fibronectin, RGD, or other cell-adhesive peptides.

The sequential alignment and removal of two arrays of microchannels orthogonally placed relative to each other on microwell-patterned substrates may also be used to fabricate a high-throughput device. For example, if the first mold has M channels and the second mold has N channels, the ability to expose each region at their intersection allows M×N unique testing conditions. Although more complicated channel designs using the sequential placement of microfluidic molds on patterned substrates are envisioned, this linear microchannel array seems promising for its simplicity and ease of use in that the same microfluidic mold rotated 90° could be used as the secondary mold. An exemplary PDMS array of five parallel channels with independent inlets and a common outlet is shown in FIG. 2A. Complementary to this design, we built an array of 25 microwells that we placed directly underneath the microchannels once the two molds were aligned.

In various embodiments, a higher level of miniaturization may be achieved in comparison to multi-well (i.e. 384 and 1536) plate assays. Without being bound by any particular theory or technique, soft lithography techniques may be employed to position microwells 100 μm apart or closer with sufficient space to align individual channels on each pattern. In various embodiments, a space of 200 μm×200 μm may be sufficient for each experimental condition, which for example can provide space for 2500 tests in a 1 cm² area. The ability to perform experiments in a high-throughput manner and to integrate microfluidic components such as valves, pumps and gradient generators may be used to eliminate expensive robotics and labor costs associated with current technologies. Also, the reduction in the volume of the samples and reagents are other advantages of this technique relative to multi-well plates.

Docking cells within microstructures has a number of advantages for capturing cells inside microdevices. Although it is possible to flow cells through an array of channels and wait for them to adhere to a patterned substrate, the approach presented here can be faster, easier to employ and more practical. Another potential advantage of using microwells to immobilize cells is that so-called negative features (e.g., the microwells, which are concave with respect to the surface of the substrate) allow the microfluidic mold to be realigned and moved without disturbing the cells.

Fluids may be flowed through the channels by charging the inlet reservoirs with appropriate fluids and then drawing them through the channels using a syringe pump connected to the outlet by flexible, e.g., polyethylene, tubing. One potential limitation of using microfluidic arrays for high-throughput experimentation can be the connection between the array of microchannels and its macroscopic inputs. To reduce the necessary number of independent inlets we integrated a variety of approaches such as the use of an orthogonally placed array of channels. To further reduce such limitations, we integrated microfluidic mixers that have been previously used to generate concentration gradients upstream from the array of channels. In these gradient generators a series of mixing and merging steps create various combinations of the inlet streams. As seen in FIGS. 5 and 6, by using a gradient generator, two independent inlets could give rise to a number of channels with a linear mixture of the two streams. These and other types of upstream modifications, such as the integration of fluidic valves, could further enhance the throughput of these devices by minimizing the number of independent inlets that are required to perform a large number of experiments.

The reversible sealing of PDMS molds can be a potentially powerful tool for high-throughput technology because it allows the integration of microchannels on patterned substrates. Additional techniques may be exploited as well. Alternative approaches for creating a robust reversibly sealed PDMS—substrate bonding include making the surfaces around the microfluidic channels hydrophobic. The hydrophobic surfaces can be used to minimize fluid retention during the conformal contact between the substrate and the PDMS mold. Negative pressure (i.e. vacuum) systems may be used to hold the PDMS onto the substrate. These approaches can, e.g. increase the bonding strength of channels onto the substrate.

The substrate and microchannel molds may be aligned manually under an optical microscope. In various embodiments, more robust alignment methods such as micromanipulators and lock-and-key systems for precisely fitting a PDMS mold on a patterned substrate may be employed. Also, while PDMS microfluidic devices remain stable and leak-free for at least a few hours, the use of external forces (e.g. clamps, etc.) to reinforce the microchannel-substrate sealing may further enhance the stability and lifetime of these devices.

Cells may be deposited into the wells simply by adding them to a fluid being flowed through the channels. It is possible to deposit different cells along each channel if desired. Cell suspensions having a desired concentration of cells may be deposited into the inlet reservoirs and drawn through the channels. The flow may be stopped for a few minutes, for example, between about 5 and about 20 minutes, to sediment the cells into the microwells. One skilled in the art will recognize that the flow rate, cell concentration, and flow stop time may all be optimized to deposit a desired number of cells into each well. Excess cells may be removed by aspirating the cells from the inlet reservoir with a pipette and flowing medium through the channels. The cells may be suspended in the microwells or may be adhered to a substrate or a 3D matrix in the wells. In various embodiments, a cell adhesive material may be deposited in the wells, for example, using robotic techniques, microfluidic techniques, photolithographic techniques, or microstamping techniques. For example, a stamp may be used to deposit a cell and protein resistant coating on the surface of the substrate, following which the wells may be coated with a cell adhesive material. Hydrogels may also be molded into the wells. Alternatively or in addition, robotic or other techniques known to those of skill in the art may be used to deposit a hydrogel or prepolymer material into the wells. The prepolymer may then be polymerized by exposing the substrate to polymerizing conditions, e.g., heat or UV light. Hydrogels may also be cross-linked in the same manner.

Once the cells are docked, a variety of materials may be flowed through the channels to modify the metabolism, membrane characteristics, contrast properties, or other properties of the cells. For example, solutions containing a targeting agent may be flowed through the channels. Targeting agents may include any small molecule, bioactive agent, or biomolecule, natural or synthetic, that binds specifically to a cell surface receptor, protein or glycoprotein found at the surface of cells. In various embodiments, the targeting agent is an oligonucleotide sequence including 10¹⁰-10²⁰ nucleotides. Targeting agents may include but are not limited to antibodies and antibody fragments, nucleic acid ligands (e.g., aptamers), oligonucleotides, oligopeptides, polysaccharides, low-density lipoproteins (LDLs), folate, transferrin, asialycoproteins, gp120 envelope protein of the human immunodeficiency virus (HIV), carbohydrates, polysaccharides, enzymatic receptor ligands, sialic acid, glycoprotein, lipid, small molecule, bioactive agent, biomolecule, immunoreactive fragments such as the Fab, Fab′, or F(ab′)₂ fragments, etc. A variety of targeting agents that direct pharmaceutical compositions to particular cells are known in the art (see, for example, Cotton, et al., Methods Enzym. 217:618; 1993; incorporated herein by reference).

Solutions containing one or more growth factors may be flowed through the channels to modify the metabolism of the docked cells. Of course, the same growth factor (or any other material) may be evaluated for its effect on a variety of cells by flowing it through channels orthogonal to those along which the cells were flowed to dock them. Exemplary growth factors include, but are not limited to, activin A (ACT), retinoic acid (RA), epidermal growth factor, bone morphogenetic protein, platelet derived growth factor, hepatocyte growth factor, insulin-like growth factors (IGF) I and II, hematopoietic growth factors, peptide growth factors, erythropoietin, interleukins, tumor necrosis factors, interferons, colony stimulating factors, heparin binding growth factor (HBGF), alpha or beta transforming growth factor (α- or β-TGF), fibroblastic growth factors, epidermal growth factor (EGF), vascular endothelium growth factor (VEGF), nerve growth factor (NGF) and muscle morphogenic factor (MMP).

Solutions containing one or more contrast agents may be flowed through the channels. These contrast agents may be used to stain cells that exhibit certain surface proteins or that are producing particular materials. On a more basic level, they may be used to identify viable cells. Suitable contrast agents are well known to those of skill in the art and include, but are not limited to, fluorescent markers, radionuclides, and cellular dyes.

The microchannels may be used to flow different combinations of nutrients to various rows of cells. For example, different groups of cells may be provided media that is deficient in a particular nutrient or to which a particular nutrient has been added. Rotating the channels allows the metabolism of the cells to be characterized with different combinations of nutrients

The microwells and microfluidic channels may be used to screen potential pharmaceutical agents. Many diseases, such as HIV/AIDS and certain cancers, are treated with combinations of drugs. The resealable microchannels may be exploited to test different combinations of drugs at varying proportions compounds or entities that alter, inhibit, activate, or otherwise affect biological or chemical events. For example, pharmaceutical agents may include, but are not limited to, anti-AIDS substances, anti-cancer substances, antibiotics, immunosuppressants, anti-viral substances, enzyme inhibitors, including but not limited to protease and reverse transcriptase inhibitors, fusion inhibitors, neurotoxins, opioids, hypnotics, anti-histamines, lubricants, ranquilizers, anti-convulsants, muscle relaxants and anti Parkinson substances, anti-spasmodics and muscle contractants including channel blockers, miotics and anti-cholinergics, anti-glaucoma compounds, anti-parasite and/or anti-protozoal compounds, modulators of cell-extracellular matrix interactions including cell growth inhibitors and anti-adhesion molecules, vasodilating agents, inhibitors of DNA, RNA or protein synthesis, anti-hypertensives, analgesics, anti-pyretics, steroidal and non-steroidal anti-inflammatory agents, anti-angiogenic factors, anti-secretory factors, anticoagulants and/or antithrombotic agents, local anesthetics, ophthalmics, prostaglandins, anti-depressants, anti-psychotic substances, anti-emetics, and imaging agents. In a various embodiments, the pharmaceutical agent is a drug. A more complete listing of specific drugs suitable for use in the present invention may be found in “Pharmaceutical Substances: Syntheses, Patents, Applications” by Axel Kleemann and Jurgen Engel, Thieme Medical Publishing, 1999; the “Merck Index: An Encyclopedia of Chemicals, Drugs, and Biologicals”, Edited by Susan Budavari et al., CRC Press, 1996, and the United States Pharmacopeia-25/National Formulary-20, published by the United States Pharmcopeial Convention, Inc., Rockville Md., 2001, all of which are incorporated herein by reference.

Of course, the microfluidic channels may be replaced or moved to direct the various materials over different groups of cells. For example, one set of growth factors may be administered to particular rows of docked cells, following which a second set of growth factors may be administered to orthogonal groups of cells by rotating the microchannels. Flushing the microchannels with PBS or other appropriate solution allows two materials to be sequentially delivered to a given row of cells without replacing the microchannels.

Aspects of the present inventions may be further understood in light of the following examples, which are not exhaustive and which should not be construed as limiting the scope of the present inventions in any way.

The examples below demonstrate various embodiments in which multiphenotype cell arrays are produced. However, the techniques described herein may be used for other applications that require the delivery of multiple fluids to specific regions of a substrate in a high-throughput manner.

### EXAMPLES

Fabrication of PDMS Microfluidic Molds and Channel Arrays

PDMS channel arrays and microfluidic molds were fabricated by casting PDMS (Sylgard 184 Silicon elastomer, Essex Chemical) against a complementary relief structure using techniques such as described in 14, 20, and 22 the entire contents of which are herein incorporated by reference. Two patterns were generated: a 5×5 array of circles of 75 μm in diameter, and an array of 5 channels with an individual channel width of 150 μm. These masks were subsequently used to generate a pattern of 80 μm high SU-8 photoresist on silicon wafers using contact photolithography to generate a negative ‘master.’ Positive replicas were fabricated by molding PDMS by curing the prepolymer (a mixture of 10:1 silicon elastomer and the curing agent provided by the manufacturer) on the silicon masters at 70° C. for 2 h. The PDMS mold was then peeled from the silicon wafer and cut prior to use. The stamps had protruding (positive) features that were used to fabricate replicate microfluidic molds, patterned microwells, or channel arrays.

For each array of microchannels, holes were drilled through the inlets and the outlet. For the inlets, independent reservoirs measuring about 3 mm in diameter were cut. Metal tubing was inserted into the outlet, sealed with epoxy, and connected to a piece of plastic tubing. This PDMS microchannel assembly was plasma cleaned for 30-45 s along with a 5×5 well patterned PDMS mold. The PDMS microchannels were manually aligned on the 5×5 PDMS substrates under a microscope, and were reversibly sealed by bringing the two surfaces into contact and applying pressure. In some experiments, plasma treatment was limited to the regions of the PDMS molds immediately surrounding the microwell or microchannel arrays. This was done by covering the rest of the substrate with a reversibly sealed piece of PDMS. This process allowed the channels and the wells to be hydrophilic while allowing the rest of the substrate to remain hydrophobic.

Cell Cultures

All cells were manipulated under sterile tissue culture hoods and maintained in a 5% CO₂ humidified incubator at 37° C. Cell lines were purchased from Advanced Type Culture Collection (ATCC), and cell culture reagents were purchased from Gibco Invitrogen Corp. unless otherwise stated. Saos-2 and NIH-3T3 murine embryonic fibroblasts were maintained in Dulbecco's modified eagle medium (DMEM) supplemented with 10% fetal bovine serum (FBS). Once the cells were confluent, they were trypsinized (0.25% in EDTA, Sigma) and passaged at a 1:5 subculture ratio. AML12 murine hepatocytes were maintained in a medium comprised of 90% 1:1 (v/v) mixture of DMEM and Ham's F12 medium with 0.005 mg mL⁻¹ insulin, 0.005 mg mL⁻¹ transferrin, 5 ng mL⁻¹ selenium, and 40 ng mL⁻¹ dexamethasone, and 10% FBS. Confluent dishes of AML12 and NIH-3T3 cells were passaged and fed every 3-4 days. Murine embryonic stem (ES) cells (R1 strain) were maintained on gelatin treated dishes in 15% ES-qualified FBS in DMEM knockout medium. ES cells were fed daily and passaged every 3 days at a subculture ratio of 1:4. The prostate PC3 cell line was cultured in RPMI-1640 and Ham's F12K medium, respectively, supplemented with 100 U mL⁻¹ aqueous Penicillin G, 100 μg mL⁻¹ Streptomycin, and 10% fetal bovine serum. Confluent culture flasks were passaged every 4 days.

Reversible Sealing and Cell Docking

To fabricate the device, the PDMS microfluidic mold was aligned under a microscope on the array of wells so that each row of wells was centered within the channels. Once the two PDMS pieces were reversibly sealed, cells were deposited in the five inlet reservoirs and flowed through the channels under negative pressure. The outlet was connected to a syringe pump (New Era Pump Systems Inc.) by polyethylene tubing, and the flow was regulated by operating the pump under either positive or negative pressures. To minimize the formation of bubbles within the microwells, ethanol was flowed through the channels at >10 μl min⁻¹, followed by a PBS wash. The channels were tested for leakage by flowing a visible dye such as Trypan blue in alternating lanes under negative pressure at 5-10 μl min⁻¹.

To seed the cells, 25-50 μl of each cell suspension (3×10⁷ cells ml⁻¹) was deposited in the inlet reservoir of a unique microchannel and flowed through the channel at a flowrate of 2-5 μl min⁻¹ under negative pressure. In most experiments, negative pressures applied at the outlet were used in order to eliminate leakage and the need for multiple syringe pumps. To sediment the cells into the microwells, the flow was stopped for 10 min. Excess cells were removed by aspirating the cells from the inlet reservoir with a pipette, and flowing medium through the channels at flowrate of 5 μl min⁻¹.

Once the cells were captured in the wells, the PDMS molds were put into a PBS bath, and the microfluidic mold was gently peeled from the substrate. This step was required in most cases where the cells had not adhered within the channels to ensure that the cells remained in the wells. To allow for the delivery of multiple fluids to the patterned cells, secondary microfluidic molds were placed orthogonally on the cell arrays. In this process, the PDMS mold containing the multiphenotype cell arrays was dried in regions around the microwell array. Subsequently another PDMS microfluidic mold containing an array of channels was aligned and pressed onto the substrate, forming a secondary PDMS mold.

Cell Tracking and Viability

To stain with the cellular dye SYTO, cells were trypsinized and washed with DMEM medium without serum, and subsequently suspended at a concentration of 1×10⁷ cells ml⁻¹ and incubated for 4 min at room temperature. To stain with carboxyfluorescein diacetate succinimidyl ester (CFSE) dye, cells were suspended in 10 mg ml⁻¹ CFSE in PBS solution at a concentration of 1×10⁷ cells ml⁻¹ and incubated for 10 min at room temperature. Both staining reactions were quenched with the addition of an equal volume of DMEM supplemented with 10% FBS and washed. To analyze cellular viability, a live/dead assay was performed by flowing ethidium homodimer and calcein AM dissolved at 1 mg mL⁻¹ in DMEM containing 10% FBS through the channel for 20 min. PBS was then flowed through the channel to remove excess/non-specific staining.

Contact Angle Measurements

Static contact angles were measured with the system A Ramé-Hart goniometer (Mountain Lakes) equipped with a video camera was used to measure the static contact angles on drops of ˜50 μL in volume. Reported values represent averages of at least 6 independent measurements.

Fabrication of Multiphenotype Cell Arrays

To demonstrate that multiphenotype cell arrays could be generated, we used a variety of cell lines including murine embryonic stem (ES) cells, osteoblasts (Saos-2), hepatocytes (AML12), fibroblasts (NIH-3T3) and human prostate cells (PC3 cells) as model cells. Once the device was fabricated, the cells were stained with cell membrane dyes CFSE and SYTO which shows up as green and red respectively under fluorescence. After prefilling with medium and reversibly sealing, each cell type was loaded into the reservoir at the inlet of one of the channels. The stream of flowing fluid carried the cells in the channels where they could be deposited onto the low shear stress confinements within the microwells. As seen in FIG. 3, the cells were captured within the microwells. All cell types, independent of source (human or mouse) or organ of origin, could be deposited within the microchannels. Although in most experiments cells remained in suspension, the ability to capture cells and allow for their adhesion and spreading at the bottom of the microwell can permit the formation of multiphenotype arrays of adherent cell types. In order to seed the cells, the cells were either captured from the moving fluid or the fluid was stopped for <10 min to facilitate cell docking within the microchannels.

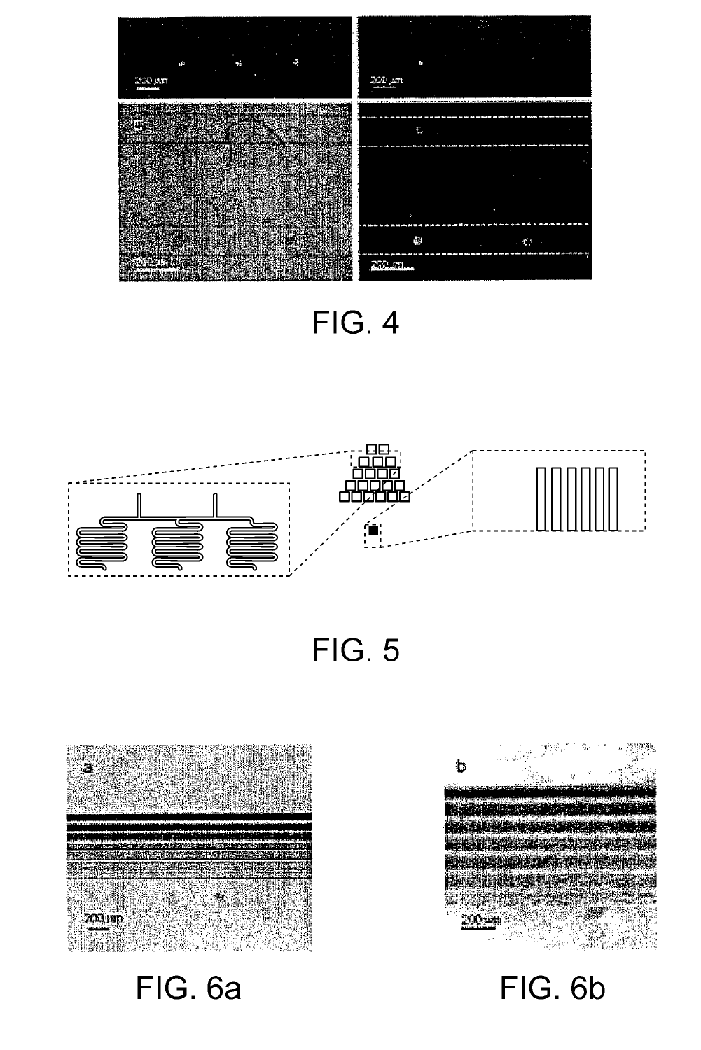

Furthermore, the microfluidic channels were used to fabricate multiphenotype cell arrays (FIG. 4). These arrays were fabricated on two-dimensional surfaces (FIG. 4B) and within microfluidic channels (FIG. 4C). To fabricate the multiphenotype cell arrays on two-dimensional substrates, cells were flowed in the channels and allowed to dock. Afterwards, the microfluidic PDMS mold was removed. To ensure that the cells remained within the microstructures, the PDMS mold was carefully and slowly removed. The removal and the placement of subsequent molds can be a delicate process that requires a balance between keeping the cells in a wet environment while allowing for the two PDMS pieces to adhere to each other under normal conditions.

Differences in the number of cells that settled in each well may introduce artifacts in subsequent (high-throughput) analyses. As shown in FIG. 4, the initial number of cells and their subsequent stability within each well was cell type dependent. This can be due to cell specific characteristics such as rate of aggregation and adhesion to the substrate. Cell types that aggregated faster and did not adhere strongly to the surfaces of the microwells both detached more easily from the microwells and led to more rapid deterioration of the patterns. Where cells do not attach to the microwells, it may be desirable to fabricate the substrate with walls or other barriers at the edge to modify the fluid flow into the well and prevent cells from washing out, or to use deeper wells or wells with a variable depth. Reducing the fluid flow rate can also reduce cell “wash-out.” Shallower wells may speed transport of reagents and other materials to and from the cells where the cells are adhered to the substrate. Process conditions such as well depth, fluid flow rates and surface chemistry and texture, may be optimized for various cell types.

Cells that underwent the docking process and the subsequent sealing of secondary microfluidic molds remained viable as measured by their ability to exclude ethidium homodimer or metabolize calcein AM. A live/dead stain was flowed through the channels of unstained cells. The cells remained alive as marked by the green color (data not shown). In addition, the cells adhered to the wells, further indicating that the cells maintained their viability.

Using the reversible adhesion between the PDMS microchannels and the underlying PDMS patterned microstructured substrate, multiple cell types were simultaneously probed. After the first set of channels was successfully removed, the cells remained immobilized within the wells. A secondary set of channels was aligned perpendicular to the first microfluidic channel set, and test solutions were flowed through each channel. As visualized in FIG. 3, the new channels did not leak and maintained isolated channel environments.

High Throughput Cell Adhesion Assay

A substrate can be prepared with or without microwells. A channel array can be used to deposit different cell adhesion promoters, e.g., fibronectin, laminin, collagen, etc. A perpendicular array can be employed to allow cells to attempt to attach to each of these surfaces. Flowing fluids at different rates through arrays oriented in the original direction, along the rows of individual cell adhesion promoters, allows the identification of which cells remain adherent at different rates.

High Throughput Antibody Dilution Assay

Cells are docked in microwells, following which microfluidic gradient generators are employed to produce a gradient of primary antibody concentrations in perpendicular flow channels. By testing multiple flow types, the optimum concentration of primary antibodies for each cell type can be determined.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present inventions have been described in conjunction with various embodiments and examples, it is not intended that the present inventions be limited to such embodiments or examples. On the contrary, the present inventions encompass various alternatives, modifications, and equivalents, as will be appreciated by those of skill in the art.

While the inventions have been particularly shown and described with reference to specific illustrative embodiments, it should be understood that various changes in form and detail may be made without departing from the spirit and scope of the present inventions. Therefore, all embodiments that come within the scope and spirit of the present inventions, and equivalents thereto, are claimed.

What is claimed is:

1. A method, comprising:
providing a substrate having a plurality of wells arranged in a predetermined pattern;
sealingly disposing a first removable channel array on the substrate, the removable channel array having a plurality of channels arranged such that first predetermined portions of the wells are disposed under predetermined channels;
flowing a material through at least a first portion of the channels of the first removable channel array;
removing the first removable channel array from the substrate;
sealingly disposing a second removable channel array on the substrate, the removable channel array having a plurality of channels, wherein the wells of a least one of the first predetermined portions are disposed under different channels than one another; and
flowing a material through at least a first portion of the channels of the second removable channel array.

2. The method of claim 1, further comprising:
removing the second removable channel array from the substrate;
sealingly disposing a third removable channel array on the substrate, the removable channel array having channels arranged such that a second predetermined portion of the wells are disposed under predetermined channels; and
flowing a material through at least a first portion of the channels of the third removable channel array.

3. The method of claim 1, wherein the first material is flowed through a first portion of the channels and a second material is flowed through a second portion of the channels.

4. The method of claim 1, wherein a different material is flowed through each of the channels.

5. The method of claim 1, wherein the channel array is fabricated from poly(dimethyl siloxane), glass, silicon dioxide, or a fluoropolymer.

6. The method of claim 1, wherein the substrate surface is fabricated from poly(dimethyl siloxane), glass, silicon dioxide or a fluoropolymer.

7. The method of claim 1, wherein the walls of the wells are treated with a material to modify their hydrophilicity, protein affinity, cell affinity, or any combination of these.

8. The method of claim 7, wherein the material is poly(3-trimethoxysilyl)-propylmethacrylate-r-poly(ethylene glycol) methyl ether (TMSMA-r-PEGMA).

9. The method of claim 7, wherein the material is an organosilane that forms self-assembled monolayers.

10. The method of claim 7, wherein ethanol is flowed through at least a portion of the channels.

11. The method of claim 1, wherein the walls of the channels are treated with a material to modify their hydrophilicity, protein affinity, cell affinity, or any combination of these.

12. The method of claim 1, wherein PEG having a predetermined molecular weight and end group is flowed through at least a portion of the channels.

13. The method of claim 1, wherein the wells have a diameter between 1 μm and 1 mm.

14. The method of claim 1, wherein the wells have a depth between 1 μm and 1 mm.

15. The method of claim 1, wherein the channels have a width between 1 μm and 1 mm.

16. A method of producing a combinatorial library of multiphenotypic cells, comprising:
providing a substrate having a plurality of wells arranged in a predetermined pattern;
depositing at least one cell in each well;
sealingly disposing a first removable channel array on the substrate, the removable channel array having a plurality of channels arranged such that first predetermined portions of the wells are disposed under predetermined channels; and
modifying a characteristic of the cells by flowing at least a first material through at least a first portion of the channels.

17. The method of claim 16, further comprising removing the first channel array from the substrate and placing a second removable channel array on the substrate such that at least a first portion of each of the predetermined portions of the wells are disposed under different channels than a second portion of each of the predetermined portions.

18. The method of claim 17, wherein each well of each of the predetermined portions of the wells is disposed under a different channel of the second removable channel array.

19. The method of claim 17, further comprising repeating the method of claim 17 with a third removable channel array.

20. The method of claim 16, wherein the first material is flowed through a first portion of the channels and a second material is flowed through a second portion of the channels.

21. The method of claim 16, wherein a different material is flowed through each of the channels.

22. The method of claim 16, wherein the channel array is fabricated from poly(dimethyl siloxane), glass, silicon dioxide, or a fluoropolymer.

23. The method of claim 16, wherein the substrate surface is fabricated from poly(dimethyl siloxane), glass, silicon dioxide or a fluoropolymer.

24. The method of claim 16, wherein the walls of the well are treated with a material to modify their hydrophilicity, protein affinity, cell affinity, or any combination of these.

25. The method of claim 24, wherein the material is poly(3-trimethoxysilyl)-propylmethacrylate-r-poly(ethylene glycol) methyl ether (TMSMA-r-PEGMA).

26. The method of claim 24, wherein the material is an organosilane that forms self-assembled monolayers.

27. The method of claim 24, wherein ethanol is flowed through at least a portion of the channels.

28. The method of claim 16, wherein the walls of the channels are treated with a material to modify their hydrophilicity, protein affinity, cell affinity, or any combination of these.

29. The method of claim 16, wherein the first material comprises a targeting agent, a nutrient medium, a pharmaceutically active agent, a contrast agent, or a growth factor.

30. The method of claim 29, wherein the targeting agent is one or more of an oligonucleotide, an oligopeptide, a polysaccharide, an antibody, an antibody fragment, a nucleic acid ligand, a low density lipoprotein, folate, transferrin, an asialycoprotein, a gp120 envelope protein of the human immunodeficiency virus (HIV), a carbohydrates, an enzymatic receptor ligand, sialic acid, a glycoprotein, a lipid, a small molecule, a bioactive agent, a biomolecule, and an immunoreactive fragment.

31. The method of claim 16, wherein PEG having a predetermined molecular weight and end group is flowed through each of the channels.

32. The method of claim 16, wherein depositing at least one cell comprises:
sealingly disposing a first removable channel array on the substrate, the removable channel array having a plurality of channels arranged such that predetermined portions of the wells are disposed under predetermined channels; and
flowing a suspension of a solvent and cells through each of the channels.

33. The method of claim 32, further comprising stopping the flow of the suspension for a predetermined time interval, thereby allowing cells to settle into the wells, and renewing the flow of the solvent through the channels.

34. The method of claim 16, wherein the wells have a diameter between 1 μm and 1 mm.

35. The method of claim 16, wherein the wells have a depth between 1 μm and 1 mm.

36. The method of claim 16, wherein the channels have a width between 1 μm and 1 mm.
